(19) United States
(12) Patent Application Publication
(10) Pub. No.: US 2024/0391513 A1
(43) Pub. Date: Nov. 28, 2024

(54) SHOPPING CART HANDLE GRIP ASSEMBLY

(71) Applicant: Jon Finney, Moreno Valley, CA (US)

(72) Inventor: Jon Finney, Moreno Valley, CA (US)

(21) Appl. No.: 18/202,141

(22) Filed: May 25, 2023

(51) Int. Cl. B62B 5/06

(52) U.S. Cl. CPC B62B 5/069

(57) ABSTRACT

A shopping cart handle grip assembly includes a pair of tubular grips each being longitudinally split for positioning around a handle of a shopping cart. Each of the pair of tubular grips is comprised of a fluid impermeable material to inhibit bacteria from transferring between the handle of the shopping cart and a user's hands. A pair of cushions is each integrated into a respective one of the tubular grips to enhance comfort for the user. A rope is attached to and extends between the pair of tubular grips thereby inhibiting the pair of tubular grips from being separated from each other. The rope extends through the opening in the collar associated with each of the pair of tubular grips having the rope being bonded to the collar associated with each of the pair of tubular grips.

### (b) CROSS-REFERENCE TO RELATED APPLICATIONS

### (c) Statement Regarding Federally Sponsored Research or Development

Not Applicable

### (D) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to handle grip devices and more particularly pertains to a new handle grip device for inhibiting the transmission of bacteria between a user and a handle of a shopping cart. The device includes a pair of tubular grips that are longitudinally split for positioning around a handle of a shopping cart and a rope attached between the pair of tubular grips. The tubular grips are gripped by the user and the rope inhibits the pair of tubular grips from being separated from each other.

### (2) Description of Related Art Including Information Disclosed Under 37 CFR 1.97 and 1.98

The prior art relates to handle grip devices including a variety of handle covers for a shopping cart which includes tubular members that are positionable around the handle, layered wraps which are wrapped around the handle and a grip that extends perpendicularly from the handle. In no instance does the prior art disclose a pair of tubular grips which are positionable around the handle and a rope attached between the pair of tubular grips to inhibit the pair of tubular grips from being separated from each other.

### (h) BRIEF SUMMARY OF THE INVENTION

An embodiment of the disclosure meets the needs presented above by generally comprising a pair of tubular grips each being longitudinally split for positioning around a handle of a shopping cart. Each of the pair of tubular grips is comprised of a fluid impermeable material to inhibit bacteria from transferring between the handle of the shopping cart and a user's hands. A pair of cushions is each integrated into a respective one of the tubular grips to enhance comfort for the user. A rope is attached to and extends between the pair of tubular grips thereby inhibiting the pair of tubular grips from being separated from each other. The rope extends through the opening in the collar associated with each of the pair of tubular grips having the rope being bonded to the collar associated with each of the pair of tubular grips.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shopping cart handle grip assembly according to an embodiment of the disclosure.

FIG. 2 is a front view of an embodiment of the disclosure.

FIG. 3 is a top view of an embodiment of the disclosure.

FIG. 4 is a bottom view of an embodiment of the disclosure.

FIG. 5 is a right side view of an embodiment of the disclosure.

FIG. 6 is a cross sectional view taken along line 6-6 of FIG. 2 of an embodiment of the disclosure.

FIG. 7 is a cross sectional view taken along line 7-7 of FIG. 6 of an embodiment of the disclosure.

FIG. 8 is a perspective in-use view of an embodiment of the disclosure.

### (j) DETAILED DESCRIPTION OF THE INVENTION

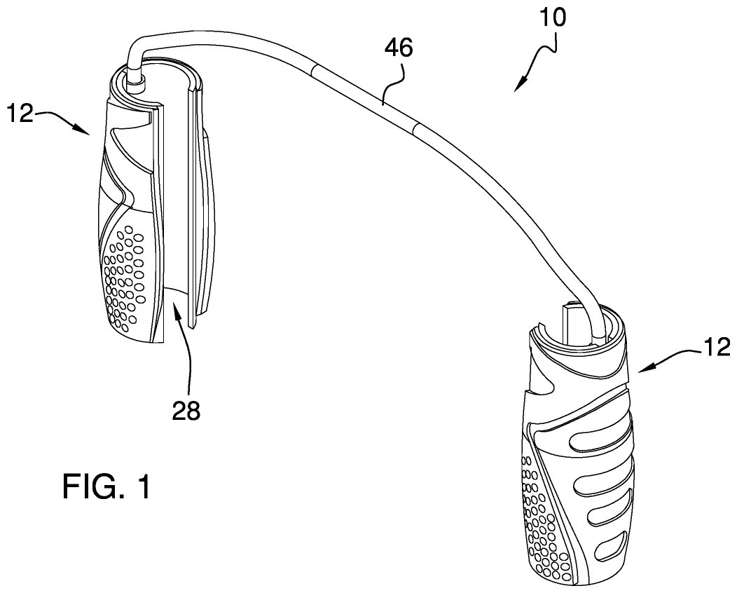

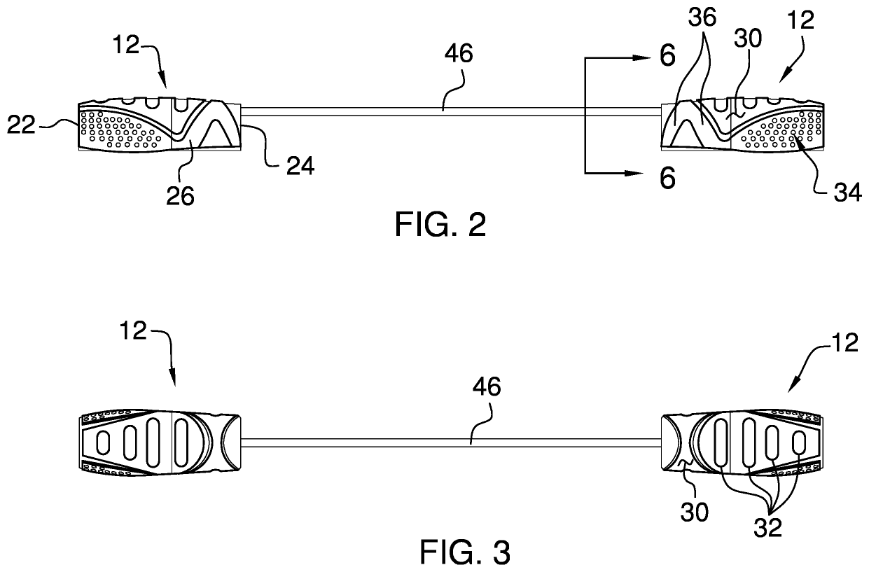

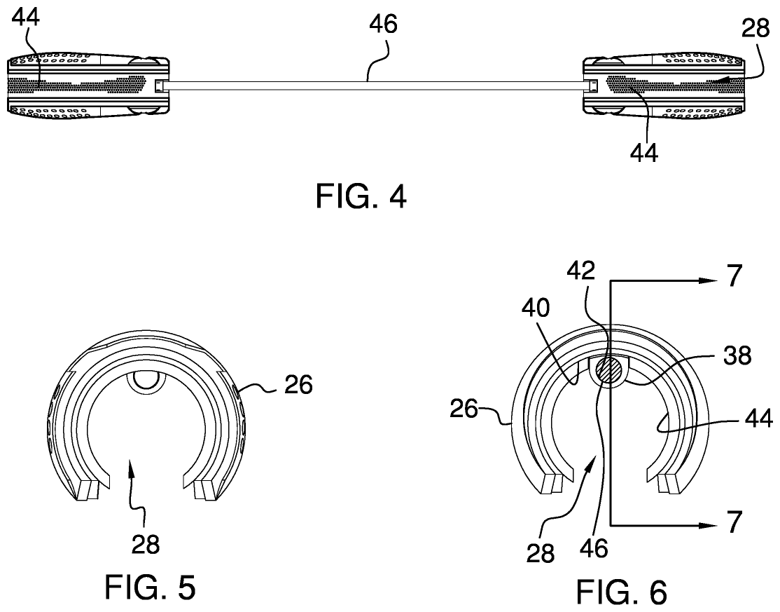

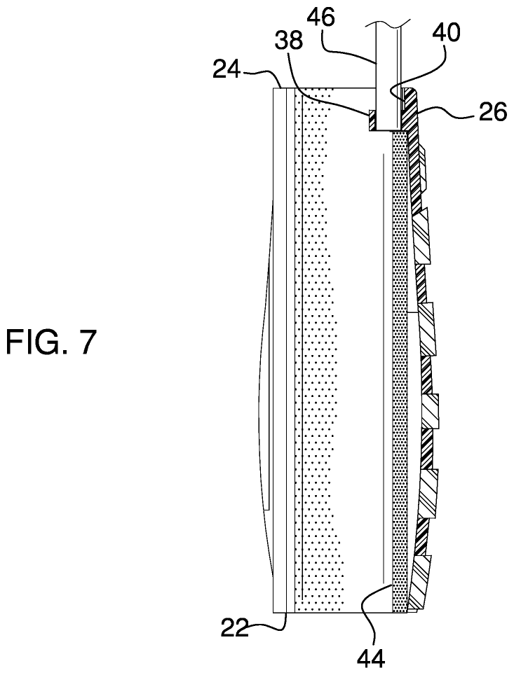

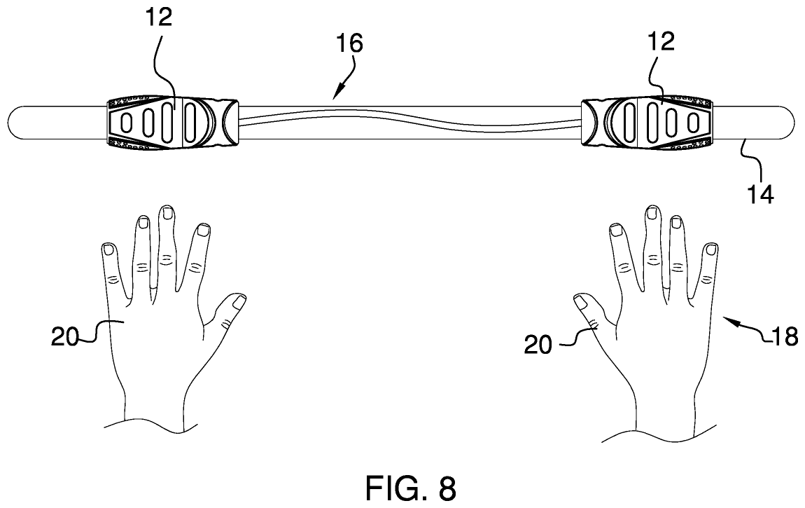

With reference now to the drawings, and in particular to FIGS. 1 through 8 thereof, a new handle grip device embodying the principles and concepts of an embodiment of the disclosure and generally designated by the reference numeral 10 will be described.

As best illustrated in FIGS. 1 through 8, the shopping cart handle grip assembly 10 generally comprises a pair of tubular grips 12 that is each longitudinally split. In this way each of the pair of tubular grips 12 can be positioned around a handle 14 of a shopping cart 16 thereby facilitating a user 18 to grip the pair of tubular grips 12. Each of the pair of tubular grips 12 is comprised of a fluid impermeable material, including but not being limited to rubber or silicone, to inhibit bacteria from transferring between the handle 14 of the shopping cart 16 and a user's hands 20. In this way the user 18 can safely employ a shopping cart 16 at a grocery store without the fear of catching an infectious disease from the handle 14.

Each of the pair of tubular grips 12 has a first end 22, a second end 24 and an outer wall 26 extending between the first end 22 and the second end 24 and each of the pair of tubular grips 12 is elongated between the first end 22 and the second end 24. The outer wall 26 of each of the pair of tubular grips 12 has a cut 28 extending between the first end 22 and the second end 24 thereby facilitating each of the pair of tubular grips 12 to be spread open. Additionally, an outer surface 30 of the outer wall 26 associated with each of the tubular grips 12 has a plurality of ovoid depressions 32 that are spaced apart from each other and are distributed in a row between the first end 22 and the second end 24. The outer surface 30 of the outer wall 26 associated with each of the tubular grips 12 has a plurality of nubs 34 distributed around a substantial circumference of the outer wall 26. Furthermore, the outer surface 30 of the outer wall 26 has a pair of intersecting ridges 36 curving around a substantial circumference of the outer wall 26 at a point located between the plurality of ovoid depressions 32 and the second end 24 of the tubular grips 12. The ovoid depressions 32, the plurality of nubs 34 and the intersecting ridges 36 enhance gripping the tubular grips 12 enhance gripping the tubular grips 12.

Each of the tubular grips 12 has a collar 38 extending away from an inside surface 40 of the tubular grips 12 at a point positioned closer to the second end 24 than the first end 22. The collar 38 is oriented such that an axis extending between the first end 22 and the second end 24 extends through an opening 42 of the collar 38. A pair of cushions 44 is integrated into a respective one of the tubular grips 12 such that each of the cushions 44 is positioned between the respective tubular grip 12 and the handle 14 of the shopping cart 16. Furthermore, each of the pair of cushions 44 is comprised of a resiliently compressible material to enhance comfort for the user 18. Each of the cushions 44 is applied to the inside surface 40 of the respective tubular grip 12; each of the cushions 44 extends between the first end 22 and the second end 24 of the respective tubular grip 12 having each of the cushions 44 completely covering the inside surface 40 of the respective tubular grip 12.

A rope 46 is attached to and extends between the pair of tubular grips 12. In this way the rope 46 inhibits the pair of tubular grips 12 from being separated from each other. The rope 46 extends through the opening 42 in the collar 38 associated with each of the pair of tubular grips 12. Furthermore, the rope 46 is bonded to the collar 38 associated with each of the pair of tubular grips 12 thereby inhibiting the rope 46 from being removed from the collar 38 associated with each of the tubular grips 12.

In use, the pair of tubular grips 12 and the rope 46 are carried with the user 18 when the user 18 is grocery shopping, for example, or any other type of shopping that involves pushing a shopping cart 16 that is available for public use. The pair of tubular grips 12 are positioned around the handle 14 of the shopping cart 16 to facilitate the user 18 to grip the pair of tubular grips 12 rather than the handle 14. In this way the user 18 does not come into contact with bacteria and other pathogens that might be located on the handle 14. Furthermore, the pair of tubular grips 12 is removed from the handle 14 when the user 18 is finished with the shopping cart 16 so the tubular grips 12 are available for future use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shopping cart handle grip assembly for inhibiting a person from touching a handle of a shopping cart while pushing the shopping cart, said assembly comprising:
a pair of tubular grips each being longitudinally split wherein each of said pair of tubular grips is configured to be positioned around a handle of a shopping cart thereby facilitating a user to grip said pair of tubular grips, each of said pair of tubular grips being comprised of a fluid impermeable material wherein said pair of tubular grips is configured to inhibit bacteria from transferring between the handle of the shopping cart and a user's hands;
a pair of cushions, each of said cushions being integrated into a respective one of said tubular grips wherein each of said cushions is configured to be positioned between said respective tubular grip and the handle of the shopping cart, each of said pair of cushions being comprised of a resiliently compressible material wherein said pair of cushions is configured to enhance comfort for the user; and
a rope being attached to and extending between said pair of tubular grips thereby inhibiting said pair of tubular grips from being separated from each other, said rope extending through said opening in said collar associated with each of said pair of tubular grips having said rope being bonded to said collar associated with each of said pair of tubular grips.

2. The assembly according to claim 1, wherein:
each of said pair of tubular grips has a first end, a second end and an outer wall extending between said first end and said second end, each of said pair of tubular grips being elongated between said first end and said second end;
said outer wall of each of said pair of tubular grips has a cut extending between said first end and said second end thereby facilitating each of said pair of tubular grips to be spread open;
an outer surface of said outer wall associated with each of said tubular grips has a plurality of ovoid depressions being spaced apart from each other and being distributed in a row between said first end and said second end wherein said ovoid depressions are configured to enhance gripping said tubular grips;
said outer surface of said outer wall associated with each of said tubular grips has a plurality of nubs being distributed around a substantial circumference of said outer wall wherein said plurality of nubs is configured to enhance gripping said tubular grips; and
said outer surface of said outer wall has a pair of intersecting ridges curving around a substantial circumference of said outer wall at a point located between said plurality of ovoid depressions and said second end of said tubular grips wherein said intersecting ridges are configured to enhance gripping said tubular grips.

3. The assembly according to claim 2, wherein each of said cushions is applied to said inside surface of said respective tubular grip, each of said cushions extending between said first end and said second end of said respective tubular grip having each of said cushions completely covering said inside surface of said respective tubular grip.

4. The assembly according to claim 2, wherein each of said tubular grips has a collar extending away from an inside surface of said tubular grips at a point being positioned closer to said second end than said first end, said collar being oriented such that an axis extending between said first end and said second end extends through an opening of said collar.

5. The assembly according to claim 4, wherein said rope extends through said opening in said collar associated with each of said pair of tubular grips having said rope being bonded to said collar associated with each of said pair of tubular grips.

6. A shopping cart handle grip assembly for inhibiting a person from touching a handle of a shopping cart while pushing the shopping cart, said assembly comprising:
a pair of tubular grips each being longitudinally split wherein each of said pair of tubular grips is configured to be positioned around a handle of a shopping cart thereby facilitating a user to grip said pair of tubular grips, each of said pair of tubular grips being comprised of a fluid impermeable material wherein said pair of tubular grips is configured to inhibit bacteria from transferring between the handle of the shopping cart and a user's hands, each of said pair of tubular grips having a first end, a second end and an outer wall extending between said first end and said second end, each of said pair of tubular grips being elongated between said first end and said second end, said outer wall of each of said pair of tubular grips having a cut extending between said first end and said second end thereby facilitating each of said pair of tubular grips to be spread open, an outer surface of said outer wall associated with each of said tubular grips having a plurality of ovoid depressions being spaced apart from each other and being distributed in a row between said first end and said second end wherein said ovoid depressions are configured to enhance gripping said tubular grips, said outer surface of said outer wall associated with each of said tubular grips having a plurality of nubs being distributed around a substantial circumference of said outer wall wherein said plurality of nubs is configured to enhance gripping said tubular grips, said outer surface of said outer wall having a pair of intersecting ridges curving around a substantial circumference of said outer wall at a point located between said plurality of ovoid depressions and said second end of said tubular grips wherein said intersecting ridges are configured to enhance gripping said tubular grips, each of said tubular grips having a collar extending away from an inside surface of said tubular grips at a point being positioned closer to said second end than said first end, said collar being oriented such that an axis extending between said first end and said second end extends through an opening of said collar;
a pair of cushions, each of said cushions being integrated into a respective one of said tubular grips wherein each of said cushions is configured to be positioned between said respective tubular grip and the handle of the shopping cart, each of said pair of cushions being comprised of a resiliently compressible material wherein said pair of cushions is configured to enhance comfort for the user, each of said cushions being applied to said inside surface of said respective tubular grip, each of said cushions extending between said first end and said second end of said respective tubular grip having each of said cushions completely covering said inside surface of said respective tubular grip; and
a rope being attached to and extending between said pair of tubular grips thereby inhibiting said pair of tubular grips from being separated from each other, said rope extending through said opening in said collar associated with each of said pair of tubular grips having said rope being bonded to said collar associated with each of said pair of tubular grips.
